(19) United States
(12) Patent Application Publication
(10) Pub. No.: US 2009/0318594 A1
(43) Pub. Date: Dec. 24, 2009

(54) BARIUM SULFATE-CONTAINING COMPOSITE

(75) Inventors: Sonja Grothe, Bottrop (DE); Petra Fritzen, Duisburg (DE); Jochen Winkler, Deutschland (DE); Bernd Rohe, Deutschland (DE); Birgit Bittmann, Deutschland (DE); Frank Haupert, Deutschland (DE)

Correspondence Address: FULBRIGHT & JAWORSKI, LLP, 666 FIFTH AVE, NEW YORK, NY, 10103-3198, US

(73) Assignees: SACHTLEBEN CHEMIE GMBH, Duisburg (DE); INSTITUT FÜR VERBUNDWERKSTOFFE GMBH, Kaiserslautern (DE)

(21) Appl. No.: 12/438,626

(22) PCT Filed: Aug. 27, 2007
(86) PCT No.: PCT/EP2007/058892

§ 371 Date: Feb. 24, 2009

(30) Foreign Application Priority Data
Aug. 25, 2006 (DE) 102006039855.6

(51) Int. Cl. C08K 5/521; C08K 3/10; C08K 3/30; C08K 3/32; C08K 5/42

(52) U.S. Cl. 524/148; 524/423; 524/403; 524/408; 524/413; 524/415; 524/166; 524/161

(57) ABSTRACT

Barium sulfate-containing composites, to methods for producing the same and to the use of said composites.

The invention provides a barium-sulfate-containing composite, a method for its production and the use of this composite.

From the application of conventional fillers and pigments, also known as additives, in polymer systems it is known that the nature and strength of the interactions between the particles of the filler or pigment and the polymer matrix influence the properties of a composite. Through selective surface modification the interactions between the particles and the polymer matrix can be influenced and hence the properties of the filler and pigment system in a polymer matrix, hereinafter also referred to as a composite, can be modified. A conventional type of surface modification is the functionalization of the particle surfaces using alkoxyalkylsilanes. The surface modification can serve to increase the compatibility of the particles with the matrix. Furthermore, a binding of the particles to the matrix can also be achieved through the appropriate choice of functional groups. The disadvantage of using conventional fillers is that owing to their particle size they scatter visible light intensely and so the transparency of the composite is markedly reduced. Moreover, the poor chemical resistance of conventional fillers such as calcium carbonate, for example, is a disadvantage for many applications.

A second possibility for improving the mechanical properties of polymer materials is the use of ultrafine particles. U.S. Pat. No. 6,667,360 discloses polymer composites containing 1 to 50 wt. % of nanoparticles having particle sizes from 1 to 100 nm. Metal oxides, metal sulfides, metal nitrides, metal carbides, metal fluorides and metal chlorides are suggested as nanoparticles, the surface of these particles being unmodified. Epoxides, polycarbonates, silicones, polyesters, polyethers, polyolefines, synthetic rubber, polyurethanes, polyamide, polystyrenes, polyphenylene oxides, polyketones and copolymers and blends thereof are cited as the polymer matrix. In comparison to the unfilled polymer, the composites disclosed in U.S. Pat. No. 6,667,360 are said to have improved mechanical properties, in particular tensile properties and scratch resistance values. A disadvantage of the disclosed ultrafine particles is that they often have a high Mohs' hardness and hence a high abrasivity. In addition, the refractive index of the materials described (for example titanium dioxide, n=2.7) is very high in comparison to the refractive index of the polymer materials. This leads to a comparatively intense light scattering and hence to a reduction in the transparency of the composites.

Barium sulfate (BaSO₄) represents a special case among typical pigments and fillers. Barium sulfate is chemically inert and does not react with typical polymers. With a Mohs' hardness of 3, barium sulfate is comparatively soft; the Mohs' hardness of titanium dioxide in the rutile modification, for example, is 6.5. The refractive index of barium sulfate is comparatively low, at n=1.64.

The patent application DE 102005025719 A1 discloses a method for incorporating de-agglomerated barium sulfate having an average particle size of less than 0.5 μm and coated with a dispersing agent, into plastics precursors, e.g. polyols. In this method a plastic is produced which includes a de-agglomerated barium sulfate containing a dispersing agent and a crystallization inhibitor. The application WO 2007/039625 A1 describes the use of barium sulfate or calcium carbonate particles containing at least one organic component in transparent polymers. A general disadvantage of using organically coated, de-agglomerated barium sulfate particles lies in the fact that the organic components cannot be used universally. The use of crystallization inhibitors is particularly disadvantageous, because they are already used in the production (precipitation) of barium sulfate particles. In this case the compatibility of the crystallization inhibitor with the plastics precursors or plastics severely limits the possible applications of the product. In an extreme case this can mean that a new product has to be developed and produced for each plastic. A further disadvantage of the de-agglomerated barium sulfate particles described in the applications DE 102005025719 A1 and WO 2007/039625 A1 consists in the particle size distribution of the secondary particles, which should have an average particle diameter of less than 2 μm, preferably <250 nm, particularly preferably <200 nm, most particularly preferably <130 nm, even more preferably <100 nm, in particular preferably <50 nm. Such fine secondary particle distributions lead to a strong dust tendency, which for reasons of safety at work is to be avoided, particularly with ultrafine particles.

A further disadvantage of the filler-modified composites described in the prior art is their inadequate mechanical properties for many applications.

The object of the present invention is to overcome the disadvantages of the prior art.

The object of the invention is in particular to provide a composite which has markedly improved values for flexural modulus, flexural strength, tensile modulus, tensile strength, crack toughness, fracture toughness, impact strength and wear rates in comparison to prior-art composites.

For certain applications of composite materials, for example in the automotive or aerospace sector, this is of great importance. Thus reduced wear rates are desirable in plain bearings, gear wheels or roller and piston coatings. These components in particular should have a long life and hence lead to an extended service life for machinery. In synthetic fibres made from PA6, PA66 or PET, for example, the tear strength values can be improved.

Surprisingly the object was achieved with composites according to the invention having the features of the main claim. Preferred embodiments are characterized in the sub-claims.

Surprisingly the mechanical and tribological properties of polymer composites were greatly improved according to the invention even with the use of precipitated, non-surface-modified barium sulfate having crystallite sizes d₅₀ of less than 350 nm (measured by the Debye-Scherrer method). This is all the more surprising as the non-surface-modified barium sulfate particles cannot form a bond between the particles and matrix.

It is known that chemical or physical bonds between the additive and matrix also have a favourable effect on improving the mechanical and tribological properties of the composite. A special embodiment according to the invention therefore provides for the provision and use of barium sulfate particles which are capable of forming such bonds. Surface-modified barium sulfate particles according to the invention are provided to that end. However, the surface modification necessary for the selective adjustment of the bond between the particles and matrix is not performed until after production of the barium sulfate particles (e.g. precipitation in aqueous media), in an additional process step.

The advantage of the subsequent surface modification lies in the high flexibility that it allows. This procedure allows particle formation to take place in the usual way during precipitation of barium sulfate, which means that particle formation is not negatively influenced by co-precipitates. In addition, it is easier to control the particle size and morphology of the barium sulfate particles.

Precipitation of the barium sulfate for use according to the invention can be performed by any method known from the prior art. Barium sulfate produced in a precipitation reactor for the precipitation of nanoscale particles, in particular a reaction cell for ultra-fast mixing of multiple reactants, for example of aqueous solutions of barium hydroxide or barium sulfide or barium chloride and sodium sulfate or sulfuric acid, is preferably used according to the invention. According to the invention, after precipitation the barium sulfate is preferably in the form of a precipitated suspension.

The barium sulfate used according to the invention is washed and concentrated to prevent the accumulating waste water from being organically contaminated. The barium sulfate is now in the form of a concentrated barium sulfate suspension.

The concentrated barium sulfate suspension can be dried by spray-drying, freeze-drying and/or mill-drying. Depending on the drying method, a subsequent milling of the dried powder may be necessary. Milling can be performed by methods known per se.

Spray-dried barium sulfate powders are preferably used to produce the composites according to the invention. These have the advantage that the relatively coarse spray-dryer agglomerates form a low-dust and very free-flowing powder which also disperses surprisingly well.

The composite according to the invention contains a polymer matrix having 0.1 to 60 wt. % of precipitated barium sulfate particles, with average crystallite sizes d₅₀ of less than 350 nm (measured by the Debye-Scherrer method). The crystallite size d₅₀ is preferably less than 200 nm, particularly preferably 3 to 50 nm. According to the invention the barium sulfate particles can be both surface-modified and non-surface-modified.

The composites according to the invention can also contain components known per se to the person skilled in the art, for example mineral fillers, glass fibres, stabilizers, process additives (also known as protective systems, for example dispersing aids, release agents, antioxidants, anti-ozonants, etc.), pigments, flame retardants (e.g. aluminium hydroxide, antimony trioxide, magnesium hydroxide, etc.), vulcanization accelerators, vulcanization retarders, zinc oxide, stearic acid, sulfur, peroxide and/or plasticizers.

A composite according to the invention can for example additionally contain up to 80 wt. %, preferably 10 to 80 wt. %, of mineral fillers and/or glass fibres, up to 10 wt. %, preferably 0.05 to 10 wt. %, of stabilisers and process additives (e.g. dispersing aids, release agents, antioxidants, etc.), up to 10 wt. % of pigment and up to 40 wt. % of flame retardant (e.g. alurninium hydroxide, antimony trioxide, magnesium hydroxide, etc.).

A composite according to the invention can for example contain 0.1 to 60 wt. % of barium sulfate, 0 to 80 wt. % of mineral fillers and/or glass fibres, 0.05 to 10 wt. % of stabilisers and process additives (e.g. dispersing aids, release agents, antioxidants, etc.), 0 to 10 wt. % of pigment and 0 to 40 wt. % of flame retardant (e.g. aluminium hydroxide, antimony trioxide, magnesium hydroxide, etc.).

The polymer matrix can consist according to the invention of a thermoplastic, a high-performance plastic or an epoxy resin. Polyester, polyamide, PET, polyethylene, polypropylene, polystyrene, copolymers and blends thereof, polycarbonate, PMMA or polyvinyl chloride, for example, are suitable as thermoplastic materials. PTFE, fluoro-thermoplastics (e.g. FEP, PFA, etc.), PVDF, polysulfones (e.g. PES, PSU, PPSU, etc.), polyetherimide, liquid-crystalline polymers and polyether ketones are suitable as high-performance plastics. Epoxy resins are also suitable as the polymer matrix.

Ultrafine barium sulfate particles without surface modification can be used according to the invention. Alternatively, in a particular embodiment, the barium sulfate particles can have an inorganic and/or organic surface modification.

The inorganic surface modification of the ultrafine barium sulfate typically consists of at least one inorganic compound selected from aluminium, antimony, barium, calcium, cerium, chlorine, cobalt, iron, phosphorus, carbon, manganese, oxygen, sulfur, silicon, nitrogen, strontium, vanadium, zinc, tin and/or zirconium compounds or salts. Sodium silicate, sodium aluminate and aluminium sulfate are cited by way of example.

The inorganic surface treatment of the ultrafine BaSO₄ takes place in an aqueous slurry. The reaction temperature should preferably not exceed 50° C. The pH of the suspension is set to pH values in the range above 9, using NaOH for example. The post-treatment chemicals (inorganic compounds), preferably water-soluble inorganic compounds such as, for example, aluminium, antimony, barium, calcium, cerium, chlorine, cobalt, iron, phosphorus, carbon, manganese, oxygen, sulfur, silicon, nitrogen, strontium, vanadium, zinc, tin and/or zirconium compounds or salts, are then added whilst stirring vigorously. The pH and the amounts of post-treatment chemicals are chosen according to the invention such that the latter are completely dissolved in water. The suspension is stirred intensively so that the post-treatment chemicals are homogeneously distributed in the suspension, preferably for at least 5 minutes. In the next step the pH of the suspension is lowered. It has proved advantageous to lower the pH slowly whilst stirring vigorously. The pH is particularly advantageously lowered to values from 5 to 8 within 10 to 90 minutes. This is followed according to the invention by a maturing period, preferably a maturing period of approximately one hour. The temperatures should preferably not exceed 50° C. The aqueous suspension is then washed and dried. Possible methods for drying ultrafine, surface-modified BaSO₄ include spray-drying, freeze-drying and/or mill-drying, for example. Depending on the drying method, a subsequent milling of the dried powder may be necessary. Milling can be performed by methods known per se.

To produce silanized, ultrafine, surface-modified BaSO₄ particles, an aqueous BaSO₄ suspension consisting of already inorganically surface-modified BaSO₄ particles is additionally modified with at least one silane. Alkoxyalkylsilanes are preferably used as silanes, the alkoxyalkylsilanes particularly preferably being selected from octyltriethoxysilane, gamma-methacrylopropyltrimethoxysilane, gamma-glycidoxypropyltrimethoxysilane, gamma-aminopropyltriethoxysilane, gamma-aminopropyltrimethoxysilane, gamma-isocyanatopropyltriethoxysilane, vinyltrimethoxysilane and/or hydrolysed silanes, such as gamma-aminopropylsilsesquioxane (GE). To this end an alkoxyalkylsilane is added to a BaSO₄ suspension consisting of inorganically surface-modified BaSO₄ particles, before or after washing, whilst stirring vigorously or dispersing. This is followed according to the invention by a maturing time, preferably a maturing time of 10 to 60 minutes, preferably at temperatures of at most 40° C. The process then continues in the manner already described. Alternatively, the alkoxyalkylsilane can be applied to the inorganically modified particles after drying, by blending.

The following compounds are particularly suitable according to the invention as organic surface modifiers: polyethers, silanes, polysiloxanes, polycarboxylic acids, fatty acids, polyethylene glycols, polyesters, polyamides, polyalcohols, organic phosphonic acids, titanates, zirconates, alkyl and/or aryl sulfonates, alkyl and/or aryl sulfates, alkyl and/or aryl phosphoric acid esters.

Organically surface-modified barium sulfate can be produced by methods known per se. According to the invention a barium component is added to the barium sulfate suspension to produce a barium excess. Any water-soluble barium compound, for example barium sulfide, barium chloride and/or barium hydroxide, can be used as the barium component. The barium ions adsorb at the surfaces of the barium sulfate particles.

Then suitable organic compounds are added to this suspension whilst stirring vigorously and/or during a dispersion process. The organic compounds should be chosen such that they form a poorly soluble compound with barium ions. The addition of the organic compounds to the barium sulfate suspension causes the organic compounds to precipitate on the surface of the barium sulfate with the excess barium ions.

Suitable organic compounds are compounds selected from the group of alkyl and/or aryl sulfonates, alkyl and/or aryl sulfates, alkyl and/or aryl phosphoric acid esters or mixtures of at least two of these compounds, wherein the alkyl or aryl radicals can be substituted with functional groups. The organic compounds can also be fatty acids, optionally having functional groups. Mixtures of at least two such compounds can also be used.

The following can be used by way of example: alkyl sulfonic acid salt, sodium polyvinyl sulfonate, sodium-N-alkyl benzenesulfonate, sodium polystyrene sulfonate, sodium dodecyl benzenesulfonate, sodium lauryl sulfate, sodium cetyl sulfate, hydroxylamine sulfate, triethanol ammonium lauryl sulfate, phosphoric acid monoethyl monobenzyl ester, lithium perfluorooctane sulfonate, 12-bromo-1-dodecane sulfonic acid, sodium-10-hydroxy-1-decane sulfonate, sodium-carrageenan, sodium-10-mercapto-1-cetane sulfonate, sodium-16-cetene(1) sulfate, oleyl cetyl alcohol sulfate, oleic acid sulfate, 9,10-dihydroxystearic acid, isostearic acid, stearic acid, oleic acid.

The organically modified barium sulfate can either be used directly in the form of the aqueous paste or can be dried before use. Drying can be performed by methods known per se. Suitable drying options are in particular the use of convection-dryers, spray-dryers, mill-dryers, freeze-dryers and/or pulse-dryers. Other dryers can also be used according to the invention, however. Depending on the drying method, a subsequent milling of the dried powder may be necessary. Milling can be performed by methods known per se. The organically modified barium sulfate preferably has an average particle diameter of d₅₀=1 nm to 100 μm, preferably d₅₀=1 nm to 1 μm, particularly preferably d₅₀=5 nm to 0.5 μm, and prior to organic modification it is preferably dispersed to the primary particle size.

The primary particles have a logarithmic particle size distribution with a median of d=1 to 5000 nm, preferably d=1 to 1000 nm, particularly preferably d=5 to 500 nm, with a geometric standard deviation of σ_{g}<1.5, preferably σ_{g}<1.4.

Following the organic modification the organically modified barium sulfate can be additionally post-treated with functional silane derivatives or functional siloxanes. The following can be used by way of example: octyltriethoxysilane, methyltriethoxysilane, γ-methacryloxypropyltrimethoxysilane, γ-glycidyloxypropyltrimethoxysilane, γ-aminopropyltriethoxysilane, γ-isocyanatopropyltriethoxysilane, vinyltrimethoxysilane.

According to the invention the organically surface-modified barium sulfate particles optionally have one or more functional groups, for example one or more hydroxyl, amino, carboxyl, epoxy, vinyl, methacrylate and/or isocyanate groups, thiols, alkyl thiocarboxylates, di- and/or polysulfide groups.

The surface modifiers can be chemically and/or physically bound to the particle surface. The chemical bond can be covalent or ionic. Dipole-dipole or van der Waals bonds are possible as physical bonds. The surface modifiers are preferably bound by means of covalent bonds or physical dipole-dipole bonds.

According to the invention the surface-modified barium sulfate particles have the ability to form a partial or complete chemical and/or physical bond with the polymer matrix via the surface modifiers. Covalent and ionic bonds are suitable as chemical bond types. Dipole-dipole and van derWaals bonds are suitable as physical bond types.

In order to produce the composite according to the invention a masterbatch can preferably be produced first, which preferably contains 5 to 80 wt. % of barium sulfate. This masterbatch can then either be diluted with the crude polymer only or mixed with the other constituents of the formulation and optionally dispersed again.

In order to produce the composite according to the invention a method can also be chosen in which the barium sulfate is first incorporated into organic substances, in particular into polyols, polyglycols, polyethers, dicarboxylic acids and derivatives thereof, AH salt, caprolactam, paraffins, phosphoric acid esters, hydroxycarboxylic acid esters, cellulose, styrene, methyl methacrylate, organic diamides, epoxy resins and plasticizers (inter alia DOP, DIDP, DINP), and dispersed. These organic substances with added barium sulfate can then be used as the starting material for production of the composite.

Conventional dispersing methods, in particular using melt extruders, high-speed mixers, triple roll mills, ball mills, bead mills, submills, ultrasound or kneaders, can be used to disperse the barium sulfate in the masterbatch or in organic substances. The use of submills or bead mills with bead diameters of d <1.5 mm is particularly advantageous.

The composite according to the invention surprisingly has outstanding mechanical and tribological properties. In comparison to the unfilled polymer the composite according to the invention has markedly improved values for flexural modulus, flexural strength, tensile modulus, tensile strength, crack toughness, fracture toughness, impact strength and wear rates.

The invention provides in detail:
Composites consisting of at least one thermoplastic, at least one high-performance plastic and/or at least one epoxy resin and barium sulfate, whose crystallite size d₅₀ is less than 350 nm, preferably less than 200 nm and particularly preferably between 3 and 50 nm, and wherein the barium sulfate can be both inorganically or organically surface-modified and also non-surface-modified (hereinafter also referred to as barium sulfate composites);
Barium sulfate composites, wherein at least one polyester, polyamide, PET, polyethylene, polypropylene, polystyrene, copolymers and blends thereof, polycarbonate, PMMA, and/or PVC is used as the thermoplastic;
Barium sulfate composites, wherein at least one PTFE, fluoro-thermoplastic (e.g. FEP, PFA, etc.), PVDF, polysulfone (e.g. PES, PSU, PPSU, etc.), polyetherimide, liquid-crystalline polymer and/or polyether ketone is used as the high-performance plastic;
Barium sulfate composites, wherein an epoxy resin is used;
Barium sulfate composites, wherein the composite contains 12 to 99.8 wt. % of thermoplastic, 0.1 to 60 wt. % of barium sulfate, 0 to 80 wt. % of mineral filler and/or glass fibre, 0.05 to 10 wt. % of antioxidant, 0 to 2.0 wt. % of organic metal deactivator, 0 to 2.0 wt. % of process additives (inter alia dispersing aids, coupling agents, etc.), 0 to 10 wt. % of pigment, and 0 to 40 wt. % of flame retardant (e.g. aluminium hydroxide, antimony trioxide, magnesium hydroxide, etc.);
Barium sulfate composites, wherein the composite contains 12 to 99.9 wt. % of high-performance plastic, 0.1 to 60 wt. % of barium sulfate, 0 to 80 wt. % of mineral filler and/or glass fibre, 0 to 5.0 wt. % of process additives (inter alia dispersing aids, coupling agents), 0 to 10 wt. % of pigment;
Barium sulfate composites, wherein the composite contains 20 to 99.9 wt. % of epoxy resin, 0.1 to 60 wt. % of barium sulfate, 0 to 80 wt. % of mineral filler and/or glass fibre, 0 to 10 wt. % of process additives, 0 to 10 wt. % of pigment and 0 to 40 wt. % of aluminium hydroxide;
Barium sulfate composites, wherein the proportion of barium sulfate in the composite is 0.1 to 60 wt. %, preferably 0.5 to 30 wt. %, particularly preferably 1.0 to 20 wt. %;
Barium sulfate composites, wherein the inorganic surface modification of the ultrafine barium sulfate consists of a compound containing at least two of the following elements: aluminium, antimony, barium, calcium, cerium, chlorine, cobalt, iron, phosphorus, carbon, manganese, oxygen, sulfur, silicon, nitrogen, strontium, vanadium, zinc, tin and/or zirconium compounds or salts;
Barium sulfate composites, wherein the organic surface modification consists of one or more of the following constituents: polyethers, siloxanes, polysiloxanes, polycarboxylic acids, polyesters, polyamides, polyethylene glycols, polyalcohols, fatty acids, preferably unsaturated fatty acids, polyacrylates, alkyl sulfonates, aryl sulfonates, alkyl sulfates, aryl sulfates, alkyl phosphoric acid esters, aryl phosphoric acid esters;
Barium sulfate composites, wherein the surface modification contains one or more of the following functional groups: hydroxyl, amino, carboxyl, epoxy, vinyl, methacrylate, and/or isocyanate groups, thiols, alkyl thiocarboxylates, di- and/or polysulfide groups;
Barium sulfate composites, wherein the surface modification is covalently bound to the particle surface;
Barium sulfate composites, wherein the surface modification is ionically bound to the particle surface;
Barium sulfate composites, wherein the surface modification is bound to the particle surface by means of physical interactions;
Barium sulfate composites, wherein the surface modification is bound to the particle surface by means of a dipole-dipole or van der Waals interaction;
Barium sulfate composites, wherein the surface-modified barium sulfate particles form a bond with the polymer matrix;
Barium sulfate composites, wherein there is a chemical bond between the barium sulfate particles and the polymer matrix;
Barium sulfate composites, wherein the chemical bond between the barium sulfate particles and the polymer matrix is a covalent and/or ionic bond;
Barium sulfate composites, wherein there is a physical bond between the barium sulfate particles and the polymer matrix;
Barium sulfate composites, wherein the physical bond between the barium sulfate particles and the polymer matrix is a dipole-dipole bond (Keeson), an induced dipole-dipole bond (Debye) or a dispersive bond (van der Waals);
Barium sulfate composites, wherein there is a physical and chemical bond between the barium sulfate particles and the polymer matrix;
Method for producing the barium sulfate composite;
Method for producing the barium sulfate composite, wherein a masterbatch is produced first and the barium sulfate composite is obtained by diluting the masterbatch with the crude polymer, the masterbatch containing 5 to 80 wt. % of barium sulfate, preferably 15 to 60 wt. % of barium sulfate;
Method for producing the barium sulfate composite, wherein a masterbatch is produced first and the barium sulfate composite is obtained by diluting the masterbatch with the crude polymer and dispersing it;
Method for producing the barium sulfate composite, wherein the masterbatch is mixed with the other constituents of the formulation in one or more steps and a dispersion preferably follows;
Method for producing the barium sulfate composite, wherein the barium sulfate is first incorporated into organic substances, in particular into polyols, polyglycols, polyethers, dicarboxylic acids and derivatives thereof, AH salt, caprolactam, paraffins, phosphoric acid esters, hydroxycarboxylic acid esters, cellulose, styrene, methyl methacrylate, organic diamides, epoxy resins and plasticizers (inter alia DOP, DIDP, DINP), and dispersed, wherein the barium sulfate can be both inorganically or organically surface-modified and also non-surface-modified;
Method for producing the barium sulfate composite, wherein the organic substances with added barium sulfate are used as the starting material for production of the composite;
Method for producing the barium sulfate composite, wherein dispersion of the barium sulfate in the masterbatch or in the organic substances is performed using conventional dispersing methods, in particular using melt extruders, high-speed mixers, triple roll mills, ball mills, bead mills, submills, ultrasound or kneaders;
Method for producing the barium sulfate composite, wherein submills or bead mils are preferably used to disperse the barium sulfate;
Method for producing the barium sulfate composite, wherein bead mills are preferably used to disperse the barium sulfate, the beads preferably having diameters of d<1.5 mm, particularly preferably d<1.0 mm, most particularly preferably d<0.3 mm;
Barium sulfate composite having improved mechanical properties and improved tribological properties;
Barium sulfate composite, wherein both the strength and the toughness are improved through the use of barium sulfate particles, preferably surface-modified barium sulfate particles;
Barium sulfate composite, wherein the improvement in the strength and toughness can be observed in a flexural test or a tensile test;
Barium sulfate composite having improved impact strength and/or improved notched impact strength values;
Barium sulfate composite, wherein the wear resistance is improved through the use of barium sulfate particles, preferably surface-modified barium sulfate particles;
Barium sulfate composite having improved scratch resistance;
Barium sulfate composite having improved stress cracking resistance;
Barium sulfate composite, wherein an improvement in the creep resistance can be observed;
Use of the barium sulfate composite as a starting material for the production of moulded articles, semi-finished products, films or fibres, in particular for the production of injection-moulded parts, blow mouldings or fibres;
Use of the barium sulfate composite in the form of fibres, which are preferably characterized by improved tear strength values;
Use of the barium sulfate composite for components for the automotive or aerospace sector, in particular in the form of plain bearings, gear wheels, roller or piston coatings;
Use of the barium sulfate composite, for example for the production of components by casting, as an adhesive, as an industrial flooring, as a concrete coating, as a concrete repair compound, as an anti-corrosion coating, for casting electrical components or other objects, for the renovation of metal pipes, as a support material in art or for sealing wooden terrariums.

The invention is illustrated by means of the examples below, without being limited thereto.

### EXAMPLE 1

A precipitated barium sulfate having a crystallite size d₅₀ of 26 nm is used as the starting material. The commercially available epoxy resin Epilox A 19-03 from Leuna-Harze GmbH is used as the polymer matrix. The amine hardener HY 2954 from Vantico GmbH & Co KG is used as the hardener.

First of all the powdered barium sulfate is incorporated into the liquid epoxy resin in a content of 14 vol. % and dispersed in a high-speed mixer. Following this pre-dispersion the mixture is dispersed for 90 minutes in a submill at a speed of 2500 rpm. 1 mm zirconium dioxide beads are used as the beads. This batch is mixed with the pure resin so that after adding the hardener, composites are formed containing 2 to 10 vol. % of barium sulfate. The composites are cured in a drying oven.

Specimens having defined dimensions were produced for the mechanical tests on the composite.

The fracture toughness K_{IC} (as defined in ASTM E399-90) was determined at a testing speed of 0.1 mm/min using compact tension (CT) specimens. A sharp pre-crack was produced in the CT specimens by means of the controlled impact of a razor blade. This produces the plane strain condition at the crack tip necessary for determining the critical stress intensity factor.

Mechanical characterization was carried out in a three-point bending test as defined in DIN EN ISO 178 using specimens cut from cast sheets with a precision saw. At least five specimens measuring 80 mm×10 mm×4 mm were tested at room temperature at a testing speed of 2 mm/min.

FIG. 1 shows the fracture toughness of the composites as a function of the barium sulfate content. It can be seen that at a concentration of 10 vol. %, the fracture toughness is 66% higher in comparison to the pure resin.

In FIGS. 2 and 3 the results of the 3-point bending test on the composites are plotted against the barium sulfate concentration. The flexural modulus is increased from 2670 MPa to 3509 MPa through the use of barium sulfate. The flexural strength can be increased from 129 MPa in the pure resin to 136 MPa with 10 vol. % barium sulfate. The comparative specimen, which contains 5 vol. % of undispersed barium sulfate, exhibits an inferior flexural strength in comparison to the pure resin.

Specimens measuring 4×4×20 mm³ were cut to determine the specific wear rate of the composite. The tribological properties of these specimens were characterized by means of the block and ring model test set-up. A contact pressure of 0.6 MPa, a relative speed of 0.03 m/s and an average particle size of the counterbody surface of 22 μm were used. In this test the specific wear rate for the 10 vol. % composite was just 0.36 mm³/Nm. The pure resin had a markedly higher specific wear rate, at 0.48 mm³/Nm.

### EXAMPLE 2

A surface-modified barium sulfate having a crystallite size d₅₀ of 26 nm is used as the starting material. The barium sulfate surface is post-treated inorganically and silanized. The inorganic surface modification consists of a silicon-aluminium-oxygen compound. gamma-Glycidoxypropyltrimethoxysilane (Silquest A-187 from GE Silicones) was used for silanization.

The inorganically surface-modified barium sulfate can be produced by the following method, for example:

3.7 kg of a 6.5 wt. % aqueous suspension of ultrafine BaSO₄ particles having average primary particle diameters d₅₀ of 26 nm (result of TEM analyses) are heated to a temperature of 40° C. whilst stirring. The pH of the suspension is adjusted to 12 using 10% sodium hydroxide solution. 14.7 ml of an aqueous sodium silicate solution (284 g SiO₂/l), 51.9 ml of an aluminium sulfate solution (with 75 g Al₂O₃/l) and 9.7 ml of a sodium aluminate solution (275 g Al₂O₃/l) are added simultaneously to the suspension whilst stirring vigorously and keeping the pH at 12.0. The suspension is homogenised for a further 10 minutes whilst stirring vigorously. The pH is then slowly adjusted to 7.5, preferably within 60 minutes, by adding a 5% sulfuric acid. This is followed by a maturing time of 10 minutes, likewise at a temperature of 40° C. The suspension is then washed to a conductivity of less than 100 μS/cm and then spray-dried. The washed suspension is adjusted with demineralised water to a solids content of 20 wt. % and dispersed for 15 minutes using a high-speed mixer. 15 g of a gamma-glycidoxypropyltrimethoxysilane (Silquest A-187 from GE Silicones) are slowly added to the suspension whilst dispersing with the high-speed mixer. The suspension is then dispersed with the high-speed mixer for a further 20 minutes and then dried in a freeze-dryer.

The commercially available epoxy resin Epilox A 19-03 from Leuna-Harze GmbH is used as the polymer matrix. The amine hardener HY 2954 from Vantico GmbH & Co KG is used as the hardener.

First of all the powdered barium sulfate is incorporated into the liquid epoxy resin in a content of 14 vol. % and dispersed in a high-speed mixer. Following this pre-dispersion the mixture is dispersed for 90 minutes in a submill at a speed of 2500 rpm. 1 mm zirconium dioxide beads are used as the beads. This batch is mixed with the pure resin so that after adding the hardener, a composite is formed containing 5 vol. % of barium sulfate. The composites were cured in a drying oven.

As in Example 1 above, specimens having defined dimensions are produced, which were measured in a flexural test and with regard to their fracture toughness.

The results of the flexural test and the fracture toughness of the composite are shown in Table 1 in comparison to the results for the composite from Example 1.

In comparison to the pure resin, the resin filled with 5 vol. % of surface-modified barium sulfate has a greatly increased flexural modulus and a markedly increased flexural strength. The fracture toughness was also able to be improved through the use of surface-modified barium sulfate. In comparison to the resin filled with 5 vol. % of barium sulfate from Example 1, the flexural modulus and flexural strength of the resin filled with 5 vol. % of surface-modified barium, sulfate are markedly increased.

TABLE 1
Results of the flexural test and the test of fracture toughness

| | Flexural | Flexural | Fracture |
|---|---|---|---|
| | modulus | strength | toughness |
| Sample | [MPa] | [MPa] | [MPa m^{1/2}] |
| Pure resin (Epilox A 19-03) | 2670 | 130 | 0.71 |
| Pure resin + 5 vol. % barium | 2963 | 139 | 0.93 |
| sulfate (from Example 1) | | | |
| Pure resin + 5 vol. % surface- | 3345 | 148 | 0.76 |
| modified barium sulfate (from | | | |
| Example 2) | | | |

### EXAMPLE 3

A precipitated barium sulfate having a crystallite size d₅₀ of 26 nm is used as the starting material. In order to produce the composite, the barium sulfate was first dispersed in ethylene glycol (EG) by bead milling and then filtered through a 1 μm filter. The 30% suspension was then used to produce PET granules containing 2.5 wt. % of barium sulfate by means of polycondensation.

Specimens for tensile and flexural tests were produced from the composite and a crude PET polymer using an injection-moulding machine. The specimens were then conditioned for 96 hours at 23° C. and 50% relative humidity.

The results of the tensile test (as defined in DIN EN ISO 527) and the flexural tests (as defined in DIN EN ISO 178) are summarized in Tables 2 and 3. The tensile modulus and ultimate elongation are improved in comparison to the crude polymer. The flexural modulus and flexural strength could also be improved through the use of barium sulfate. The marked increase in the Vicat softening point from 78° C. in the crude polymer to 168° C. in the nanocomposite is also striking.

TABLE 2
Results of the tensile test on the composite comprising
PET and barium sulfate according to Example 3

| | | Ultimate |
|---|---|---|
| | Tensile | elongation |
| Sample | modulus [MPa] | [%] |
| Crude PET polymer | 2443 | 7.8 |
| Composite comprising PET and | 3068 | 0.4 |
| 2.5 wt. % barium sulfate | | |

TABLE 3
Results of the flexural test on the composite comprising
PET and barium sulfate according to Example 3

| | Flexural strength | Flexural modulus |
|---|---|---|
| Sample | [MPa] | [MPa] |
| Crude PET polymer | 89 | 2380 |
| Composite comprising PET and | 105 | 2719 |
| 2.5 wt. % barium sulfate | | |

### EXAMPLE 4

A precipitated barium sulfate having a crystallite size d₅₀ of 26 nm and whose surface is organically surface-modified with a fatty acid (stearic acid Edenor ST1) is used as the starting material.

The organically surface-modified barium sulfate can be produced by the following method, for example:

9 kg of a precipitated barium sulfate were first pin-milled. It was then mixed with 10 wt. % of stearic acid (Edenor ST19) in a Diosna mixer, causing the stearic acid to melt onto the product because of a rise in temperature. The product obtained was then pin-milled again.

A 20 wt. % masterbatch was first produced from this organically surface-modified barium sulfate and a commercial polyamide 6 (Ultramid B2715, BASF) by melt extrusion. In a second extrusion step this masterbatch was diluted to barium sulfate concentrations of 2.0 wt. % and 7.4 wt. %. An injection-moulding machine was used to prepare dumbbell test specimens for the tensile test (as defined in DIN EN ISO 527) and small specimens for the flexural test (as defined in DIN EN ISO 178). The specimens were then conditioned for 72 hours at 23° C. and 50% relative humidity. The results of the tensile tests are listed in Table 4. A clear rise in the tensile strength and tensile modulus and a reduction in the ultimate elongation can be seen in the composites as compared with the crude polymer. A marked improvement was able to be achieved in the flexural properties too (flexural modulus and flexural strength) through the use of surface-modified barium sulfate (see Table 5). The impact strength (as defined in DIN EN ISO 179) is only improved in comparison to the pure polyamide 6 with the use of 2 wt. % of surface-modified barium sulfate.

TABLE 4
Results of the tensile test on the composites comprising PA6
and surface-modified barium sulfate according to Example 4

| | Particle | Tensile | Ultimate | Tensile |
|---|---|---|---|---|
| | content | strength | elongation | modulus |
| Sample | wt. % | [MPa] | [%] | [MPa] |
| PA 6 Ultramid B2715 (BASF) | 0 | 67.99 | 108.63 | 2464.7 |
| Nanocomposite comprising | 2 | 73.7 | 22.6 | 2944.4 |
| PA 6 and surface-modified | | | | |
| barium sulfate | | | | |
| Nanocomposite comprising | 7.4 | 75.7 | 8.3 | 3038.4 |
| PA 6 and surface-modified | | | | |
| barium sulfate | | | | |

TABLE 5
Results of the flexural test and impact test
on the composites comprising PA6 and surface-modified
barium sulfate according to Example 4

| | | | | Charpy |
|---|---|---|---|---|
| | Particle | Flexural | Flexural | impact |
| | content | strength | modulus | strength |
| Sample name | wt. % | [MPa] | [MPa] | [kJ/m²] |
| PA 6 Ultramid B2715 (BASF) | 0 | 87.5 | 1920 | 92.24 |
| Nanocomposite comprising | 2 | 91.0 | 2057.6 | 99.6 |
| PA 6 and surface-modified | | | | |
| barium sulfate | | | | |
| Nanocomposite comprising | 7.4 | 94.3 | 2148.7 | 40.2 |
| PA 6 and surface-modified | | | | |
| barium sulfate | | | | |

1-31. (canceled)

32. A composite comprising a filler and a pigment in a polymer matrix, wherein the composite contains barium sulfate having a crystallite size, and at least one thermoplastic, high-performance plastic or epoxy resin, wherein the crystallite size of the barium sulfate d₅₀ is less than 350 nm, wherein the barium sulfate can be inorganically surface modified, organically surface-modified or non-surface-modified.

33. A composite according to claim 32, wherein the thermoplastic comprises at least one of a polyester, a polyamide, a PET, a polyethylene, a polypropylene, a polystyrene, a copolymer thereof, a blend thereof, a polycarbonate, PMMA or polyvinyl chloride.

34. A composite according to claim 32, wherein the high-performance plastic comprises at least one PTFE, fluoro-thermoplastic, PVDF, polysulfone, polyetherimide, liquid-crystalline polymer or polyether ketone.

35. A composite according claim 32, wherein the composite contains 12 to 99.8 wt. % of the thermoplastic, 0.1 to 60 wt. % of the barium sulfate, 0 to 80 wt. % of a mineral filler or glass fiber, 0.05 to 10 wt. % of antioxidant, 0 to 2.0 wt. % of organic metal deactivator, 0 to 2.0 wt. % of a process additive, 0 to 10 wt. % of a pigment, and 0 to 40 wt. % of a flame retardant.

36. A composite according to claim 32, wherein the composite contains 12 to 99.9 wt. % of the high-performance plastic, 0.1 to 60 wt. % of the barium sulfate, 0 to 80 wt. % of mineral filler or glass fiber, 0 to 5.0 wt. % of a process, 0 to 10 wt. % of pigment.

37. A composite according to claim 32, wherein the composite contains 20 to 99.9 wt. % of epoxy resin, 0.1 to 60 wt. % of barium sulfate, 0 to 80 wt. % of mineral filler or glass fiber, 0 to 10 wt. % of a process additives, 0 to 10 wt. % of a pigment and 0 to 40 wt. % of aluminum hydroxide.

38. A composite according to claim 32, wherein the proportion of barium sulfate in the composite is 0.1 to 60 wt. %, preferably 0.5 to 30 wt. %, particularly preferably 1.0 to 20 wt. %.

39. A composite according to claim 32, wherein the barium sulfate is surface-miodified with at least one inorganic compound.

40. A composite according to claim 39, wherein the percentage by weight of inorganic compounds relative to BaSO₄ is 0.1 to 50.0 wt. %.

41. A composite according to claim 39, wherein the inorganic compound comprises at least one of water-soluble aluminum, antimony, barium, calcium, cerium, chlorine, cobalt, iron, phosphorus, carbon, manganese, oxygen, sulfur, silicon, nitrogen, strontium, vanadium, zinc, tin or zirconium, or a salt thereof.

42. A composite according to claim 40, wherein the surface modified BaSO₄ particles are also modified with at least one silane or multiple silane.

43. A composite according to claim 42, wherein the silanes are alkoxyalkylsilanes.

44. A composite according to claim 43, wherein the alkoxyalkylsilane is selected from the group consisting of octyltriethoxysilane, gamma-methacrylopropyltrimethoxysilane, gamma-glycidoxypropyl-trimethoxysilane, gamma-aminopropyltri-ethoxy-silane, gamma-aminopropyltrimethoxy-silane, gamma-isocyan atopropyltriethoxysilane, vinyltrimethoxysilane and a hydrolyzed silane.

45. A composite according to claim 32, wherein the BaSO₄ particles have a primary particle size d₅₀ of less than or equal to 0.1 μm.

46. A composite according to claim 32, wherein the barium sulfate is surface-modified with at least one organic compound.

47. A composite according to claim 46, wherein the organic compound comprises at least one member selected from the group consisting of an alkyl sulfonate, an aryl sulfonate, an alkyl sulfate, an aryl sulfate, an alkyl phosphoric acid ester, an aryl phosphoric acid ester, wherein alkyl or aryl radicals on said organic compound are optionally substituted with functional groups, a fatty acid, and optionally having a functional group.

48. A composite according to claim 46, wherein the organic compound is selected from the group consisting of an alkyl sulfonic acid salt, sodium polyvinyl sulfonate, sodium-N-alkyl benzenesulfonate, sodium polystyrene sulfonate, sodium dodecyl benzenesulfonate, sodium lauryl sulfate, sodium cetyl sulfate, hydroxylamine sulfate, triethanol ammonium lauryl sulfate, phosphoric acid monoethyl monobenzyl ester, lithium perfluorooctane sulfonate, 12-bromo-1-dodecane sulfonic acid, sodium-10-hydroxy-1-decane sulfonate, sodium-carrageenan, sodium-10-mercapto-1-cetane sulfonate, sodium-16-cetene(1) sulfate, oleyl cetyl alcohol sulfate, oleic acid sulfate, 9,10-dihydroxystearic acid, isostearic acid, stearic acid and oleic acid.

49. A composite according to claim 48, wherein the barium sulfate has an average particle diameter of d₅₀=1 nm to 100 μm.

50. A composite according to claim 48, wherein primary particles of the barium sulfate have a logarithmic particle size distribution with a median of d=1 to 5,000 nm and a logarithmic particle size distribution with a geometric standard deviation of σ_{g}<1.5.

51. A composite according to claim 48, wherein the barium sulfate is post-treated with functional silane derivatives or functional siloxanes, wherein the functional silane derivative or functional siloxane is selected from the group consisting of an octyltriethoxysilane, a methyltriethoxysilane, a γ-methacryloxypropyltrimethoxysilane, a γ-glycidyloxypropyltrimethoxysilane, a γ-aminopropyltriethoxysilane, a γ-isocyanatopropyltriethoxysilane and a viinyltrimethoxysilane.

52. A method for producing a composite according to claim 24, wherein a masterbatch is produced from the barium sulfate and part of the crude polymer and the composite is obtained by diluting the masterbatch with the crude polymer and dispersing it.

53. A method according to claim 52, wherein a masterbatch is produced from the barium sulfate and part of the crude polymer and the composite is obtained by diluting the masterbatch with the crude polymer, wherein the masterbatch contains 5 to 80 wt. % of barium sulfate.

54. A method according to claim 52, wherein the masterbatch is mixed with the other constituents of the formulation in one or more steps to form a dispersion.

55. A method according to one or more of claim 52, wherein the barium sulfate is first incorporated into an organic substance and dispersed.

56. A method according to claim 53, wherein the organic substance with added barium sulfate are used as the starting material for production of the composite.

57. A method according to claim 53, wherein dispersion of the barium sulfate in the masterbatch or in an organic substance is performed with a melt extruder, a high-speed mixer, a triple roll mill, a ball mill, a bead mill, a submill, ultrasound or a kneader.

58. A method according to claim 57, wherein dispersion of the barium sulfate is preferably performed in the submill or the bead mill.

59. A method according to claim 52, wherein dispersion of the barium sulfate is performed in a bead mill having beads, wherein the beads having diameters of d<1.5 mm are provided.

60. A molded article, semi-finished product, films or fiber comprising the composite of claim 32.

61. An automotive or aerospace plain bearing, gear wheel, roller or piston coating comprising the composite of claim 32.

62. A component made by casting, an adhesive, an industrial flooring, a concrete coating, a concrete repair compound, an anti-corrosion coating, a casted electrical component, a renovated metal pipe, a support material in art or a wooden terrarium comprising the composite of claim 32.
